(19) United States
(12) Patent Application Publication
(10) Pub. No.: US 2015/0161647 A1
(43) Pub. Date: Jun. 11, 2015

(54) MERCHANDISE SALES DATA PROCESSING APPARATUS

(71) Applicant: TOSHIBA TEC KABUSHIKI KAISHA, Tokyo (JP)

(72) Inventors: Yasuhiro Arai, Mishima Shizuoka (JP); Kuniyoshi Yamada, Ota Tokyo (JP); Keiichi Hasegawa, Koto Tokyo (JP); Tsuyoshi Gotanda, Oota Tokyo (JP)

(21) Appl. No.: 14/475,666

(22) Filed: Sep. 3, 2014

(30) Foreign Application Priority Data
Dec. 11, 2013 (JP) 2013-256242

(51) Int. Cl. G06Q 30/02

(52) U.S. Cl. CPC G06Q 30/0233

(57) ABSTRACT

A merchandise sales data processing apparatus according to an embodiment includes an input device, a storage unit, and a processor. The input device receives first customer information, second customer information indicating the user's participation in a reward program in a store at which the user is currently purchasing merchandise, and merchandise sales data. The storage unit stores the received first customer information, the second customer information, company code information indicating the store, and reward information of the user in the reward program. A first transmission section transmits the received first customer specification information and the company code information to an outside apparatus. A privilege generation section generates the reward information when the second customer specification information is received. An electronic receipt data generation section generates and transmits the electronic receipt information including the merchandise sales data and the reward information.

### CROSS-REFERENCE TO RELATED APPLICATION

This application is based upon and claims the benefit of priority from Japanese Patent Application No. 2013-256242, filed Dec. 11, 2013, the entire contents of which are incorporated herein by reference.

### FIELD

Embodiments described herein relate generally to a merchandise sales data processing apparatus and a program thereof.

### BACKGROUND

In the related art, an electronic receipt is electronically passed to a mobile terminal or the like of a customer who purchased a merchandise from a store when the merchandise is paid for.

By making the receipt electronic—for example, by inputting customer specification information using the mobile terminal which is carried by the customer himself or using a customer card—it is possible to read electronic receipt data on a display unit of the mobile terminal, when the store transmits the electronic receipt data to the specified customer.

Meanwhile, a company which runs the store provides a reward program that allows the customer to enjoy rewards, for example, allowing the customer to earn and redeem points, as a part of customer retention. The points may be enjoyed by a point member who signed up for the program. For this reason, by operating a point card or the like which is carried by a member and by inputting a membership code, the program member is identified, and the specified member earns the points.

However, in the related art, when receiving the electronic receipt, information specifying the customer who purchased a merchandise and information specifying the member of the reward program may not be in cooperation with each other. For receiving the electronic receipt, the customer shows a mobile device, such as the mobile terminal or a customer card, which specifies the customer, and when the customer receives the service of points, the customer shows a member device, such as a point card, which specifies the point member. For this reason, the customer is required to carry both the mobile device and the member device, which is inconvenient. It is even more inconvenient to carry a plurality of member media for a plurality of stores.

### DESCRIPTION OF THE DRAWINGS

FIG. 1 illustrates an electronic receipt system according to an embodiment.

FIG. 2 illustrates an example transition screen for membership registration of a customer on a mobile device.

FIG. 3 is a block diagram illustrating a configuration of a main portion of a POS terminal.

FIG. 4 is a memory map illustrating a portion of a storage unit of the POS terminal.

FIG. 5 is a block diagram illustrating a configuration of a main portion of an electronic receipt server.

FIG. 6 is a block diagram illustrating a configuration of a main portion of an electronic receipt management server.

FIG. 7 is a memory map illustrating a portion of a storage unit of the electronic receipt management server.

FIG. 8 is a block diagram illustrating a configuration of a main portion of a mobile terminal.

FIG. 9 is a functional block diagram in the POS terminal.

FIG. 10 illustrates an example of receipt data.

FIG. 11 illustrates an example of an electronic receipt.

FIG. 12 is a flow chart illustrating an example sequence of operations for control processing in the POS terminal.

FIG. 13 is a flow chart illustrating an additional example sequence of operations for the control processing in the POS terminal.

FIG. 14 is a flow chart illustrating an additional example sequence of operations for the control processing in the POS terminal.

FIG. 15 is a flow chart illustrating an example sequence of operations for electronic receipt management processing and information transmission processing in the electronic receipt server.

FIG. 16 is a flow chart illustrating an example sequence of operations for management processing of electronic receipt information in the electronic receipt management server.

FIG. 17 is a functional block diagram related to electronic receipt reception processing and electronic receipt reading processing in the mobile terminal.

FIG. 18 is a flow chart illustrating an example sequence of operations for electronic receipt reception processing and the electronic receipt reading processing in the mobile terminal.

### DETAILED DESCRIPTION

Embodiments provide a merchandise sales data processing apparatus and a program thereof in which a customer who receives an electronic receipt may enjoy benefits of a reward program simply by carrying a mobile device.

A merchandise sales data processing apparatus according to an embodiment includes an input device, a storage unit, and a processor. The input device receives first customer information, second customer information indicating the user's participation in a reward program in a store at which the user is currently purchasing merchandise, and merchandise sales data. The storage unit stores the received first customer information, the second customer information, company code information indicating the store, and reward information of the user in the reward program. A first transmission section transmits the received first customer specification information and the company code information to an outside apparatus. A privilege generation section generates the reward information when the second customer specification information is received. An electronic receipt data generation section generates and transmits the electronic receipt information including the merchandise sales data and the reward information.

Hereinafter, an embodiment will be descried based on the drawings.

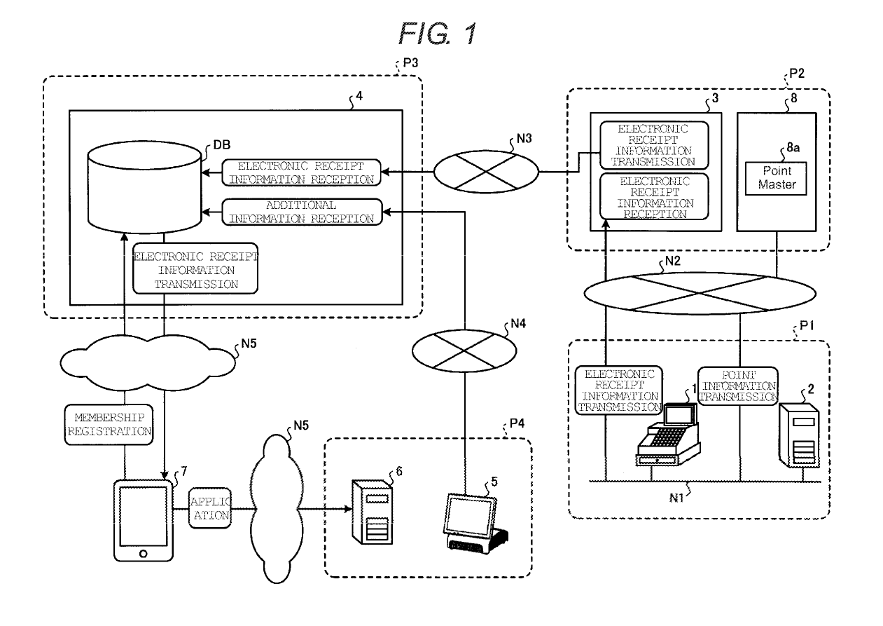

FIG. 1 illustrates a configuration of an electronic receipt system according to the embodiment. As illustrated in FIG. 1, an electronic receipt system includes a point of sales (POS) terminal 1, a store server 2, an electronic receipt server 3, an electronic receipt management server 4, a promotion setting terminal 5, a promotion management server 6, and a mobile terminal 7 which is an example of a customer terminal used for identifying a customer.

The POS terminal 1 and the store server 2 are provided in a store P1. The POS terminal 1 and the store server 2 are connected to be able to communicate with each other via an in-store network N1, such as a local area network (LAN). In addition, the POS terminal 1 and the store server 2 may be connected to a network N2 which is linked to the store P1 and a head office P2, via network equipment (not illustrated), such as a router which is connected to the in-store network N1. The network N2 may be, for example, a dedicated line, such as the Internet or a virtual private network (VPN).

The POS terminal 1 performs merchandise sales data processing. The POS terminal 1 generates receipt data including transaction content regarding purchase of merchandise, and outputs a paper receipt by printing the receipt data with a printing unit 13 (which will be described later). In addition, the POS terminal 1 outputs (transmits) electronic receipt information of the receipt data to an electronic receipt server 3 via the network N2. A transmission method of the electronic receipt information is not particularly limited, and a universal protocol, such as HTTP or HTTPS, may be used. In addition, the number of the POS terminal 1 provided in the store P1 is not particularly limited, i.e., there may be plural POS terminals 1.

The store server 2 generally performs data management of data from, for example, merchandise sales data processing which is performed at the POS terminal 1. For example, the store server 2 stores and manages the merchandise sales data which is generated from merchandise sales data processing of the POS terminal 1, and stores and manages a merchandise data file or the like which is used in the merchandise sales data processing.

In addition, the number of the POS terminal 1 disposed in the store P1 does not particularly matter, and may be plural. In addition, in the embodiment, a configuration in which the POS terminal 1 outputs the electronic receipt information is described, but the embodiment is not limited thereto. A configuration in which the electronic receipt information is output to the electronic receipt server 3 may be employed. In such a configuration, the store server 2 or a conversion apparatus (not illustrated) converts the receipt data generated at the POS terminal 1 into the data format for the electronic receipt information.

The electronic receipt server 3 is provided in the head office P2 of a company which operates the store or a chain of stores (hereinafter, refer to as a store), and functions as a receipt management server for the company which manages the receipt data for every store.

The electronic receipt server 3 receives the electronic receipt information transmitted from the POS terminal 1 via the network N2. In addition, the electronic receipt server 3 transmits the received electronic receipt information to the electronic receipt management server 4 via the network N3 which links the head office P2 and an electronic receipt center P3.

Here, the network N3 is the dedicated line, such as the Internet or the VPN. In addition, the transmission method of the electronic receipt information does not particularly matter, and may use the universal protocol such as HTTP or HTTPS.

A head office server 8 is provided at the head office P2 of the company which operates the store. The head office server 8 manages various types of information received from each of the POS terminals 1. The head office server 8 manages and analyzes turnover, and/or manages inventory of the company which operates the store.

The main office server 8 is provided with a point master 8a. The point master 8a receives, accumulates, and manages point information of each customer, the point information being generated at the POS terminal 1 of each store. For every customer, the point master 8a manages points which may be used at that moment by the customer.

The electronic receipt management server 4 is provided in the electronic receipt center P3. The electronic receipt center P3 is, for example, a third party organization, different from the company, which manages the receipt data by the electronic receipt server 3. In addition, the electronic receipt server 3 may also be managed by the third party organization.

The electronic receipt management server 4 functions as the receipt management server for the customer who collectively manages the receipt data of various companies which operate different stores. The electronic receipt management server 4 stores and manages membership data, such as a membership code which is a name or a customer code of each customer (member) who performs membership registration in a procedure or the like which will be described later, and transmission destination information (for example, an email address) of the mobile terminal 7 which is a transmission destination of the electronic receipt data, in a membership master maintained in a data base DB. In addition, the a membership management server which performs storage and management of the membership data may be employed may be separate from the electronic receipt management server 4.

In addition, the electronic receipt management server 4 receives the electronic receipt information transmitted from the electronic receipt server 3 via the network N3, and stores and manages the electronic receipt information, for every membership code in an electronic receipt management area 43a (to be described later) maintained in the database DB. More specifically, the electronic receipt information includes data elements such as the membership code and the transaction content (merchandise sales data) of the merchandise, and is managed in correlation with the membership data of the corresponding member/customer.

In addition, the electronic receipt management server 4 receives additional information, such as campaign information related to a campaign for a specified merchandise, from a promotion setting terminal 5 which is connected via a network N4 (to be described later), and stores and manages the additional information in an additional information management area 43b (to be described later) maintained in the data base DB. More specifically, the additional information is stored and managed in the data base DB in correlation with an element which corresponds to a predetermined condition.

In addition, when the electronic receipt information is stored in the data base DB, the electronic receipt management server 4 specifies the transmission destination (mobile terminal 7) by referring to the transmission destination information which is correlated with the membership code of the electronic receipt information. The electronic receipt management server 4 transmits the electronic receipt information stored in the data base DB to the transmission destination via a network N5 (which will be described later). In addition, when additional information is correlated with the electronic receipt information, the additional information is also transmitted to the transmission destination.

When an electronic receipt inquiry to designate the membership code is accepted from the mobile terminal 7 connected via the network N5 (to be described later), the electronic receipt management server 4 extracts the electronic receipt information corresponding to the membership code from the data base DB, and transmits the electronic receipt information to the mobile terminal 7. When the additional information is correlated with the electronic receipt information, the additional information is also transmitted to the mobile terminal 7 from which there is an inquiry.

The promotion setting terminal 5 and the promotion management server 6 are provided at a consumption goods maker P4 or the like. The promotion setting terminal 5 is a terminal apparatus, such as a personal computer (PC), and transmits the additional information to the electronic receipt management server 4 via the network N4. Here, the network N4 is, for example, the dedicated line, such as the Internet or the VPN. In addition, a transmission method of the additional information is not particularly limited, and the universal protocol, such as HTTP or HTTPS, may be used.

The mobile terminal 7 is a terminal apparatus, such as a smart phone, a mobile phone, a personal digital assistant (PDA), or a tablet computer, which is used by a user (customer) of the system. An application, such as a web browser, for reading various information provided on the network N5, is installed on the mobile terminal 7. In addition, instead of the mobile terminal 7, the terminal apparatus, such as a PC, may be employed.

The mobile terminal 7 performs the membership registration to the system by accessing the electronic receipt management server 4 via the network N5. Here, the network N5 is the Internet or the various public networks.

Meanwhile, the membership registration of the customer in the system is performed in a procedure as described below, for example. The customer transmits a blank mail to the electronic receipt management server 4 via the network N5, from the mobile terminal 7. The electronic receipt management server 4 transmits a uniform resource locator (URL) which links to a page for the membership registration to the received email address. The customer accesses the URL which links to the page for the membership registration from the mobile terminal 7. The mobile terminal displays the page for membership registration, which includes an input screen on which items (the name, the transmission destination information or the like) that are necessary for the membership registration are input. After the customer completes the input of the necessary items, the electronic receipt management server 4 performs the membership registration with respect to the membership master. After that, the electronic receipt management server 4 delivers a membership registration completion mail including the membership code (customer code) and a password to the mobile terminal 7. Accordingly, the membership registration is completed.

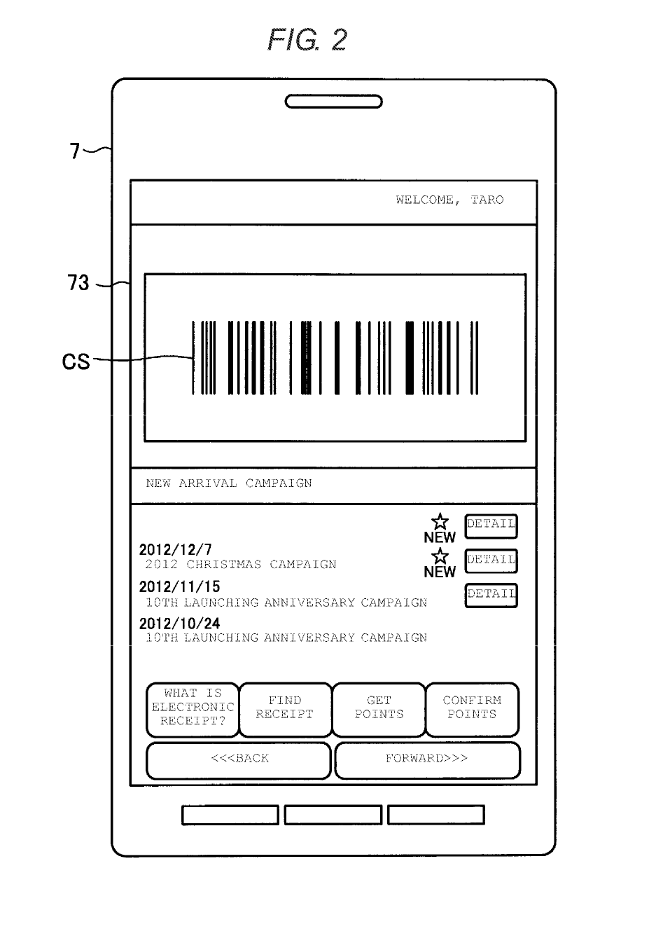

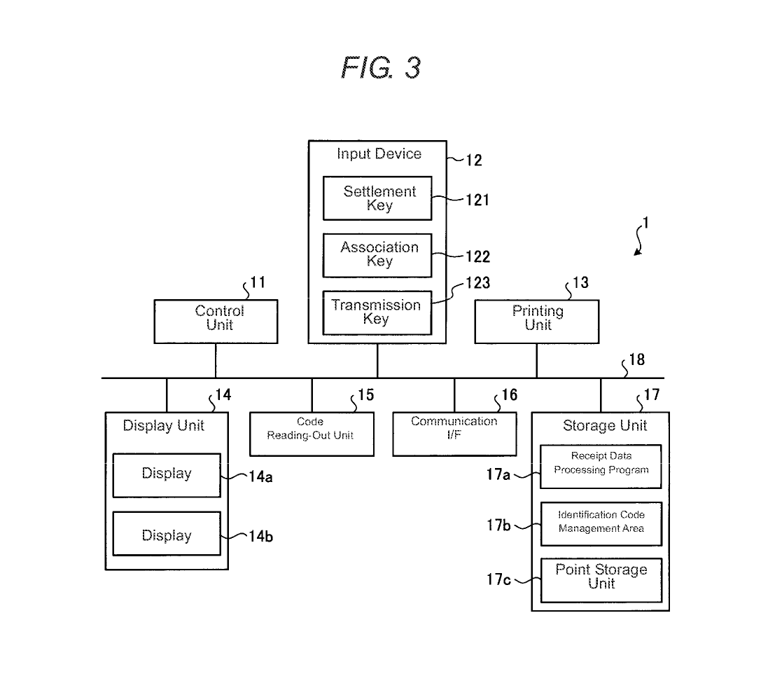

As illustrated in FIG. 2, after completing the membership registration as described above, the mobile terminal 7 displays the membership code of the customer as a code symbol CS, such as a bar code or a two-dimensional code, on a display unit 73. The customer shows the code symbol CS displayed in the mobile terminal 7 to a salesperson when the transaction is paid at the store P1. The salesperson reads out the code symbol CS displayed in the mobile terminal 7 by a code reading-out unit 15 (refer to FIG. 3) which includes a scanner, for example, and is connected to the POS terminal 1. Accordingly, it is possible that the receipt data generated after the payment by the merchandise sales data processing at the POS terminal 1 is correlated with the membership code of the customer.

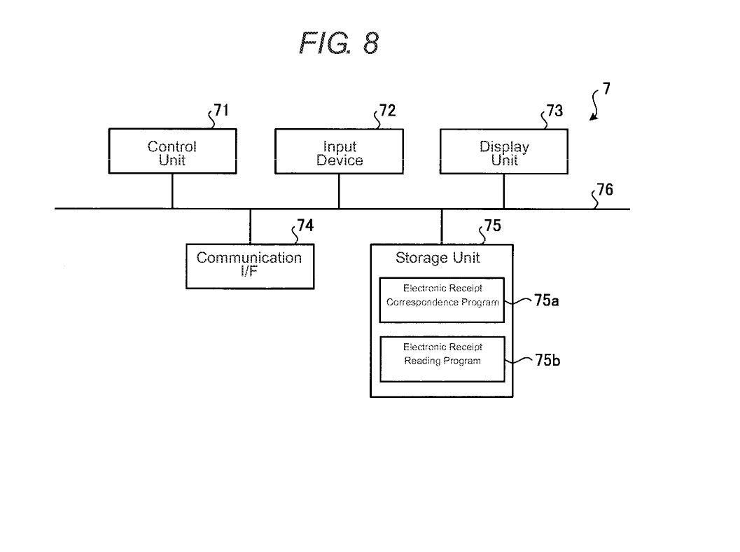

In addition, the mobile terminal 7 receives the electronic receipt information of the transaction transmitted from the electronic receipt management server 4 after the payment (transaction) at the POS terminal 1 via the network N5. By transmitting electronic receipt inquiry which designates the membership code to the electronic receipt management server 4 via the network N5, the electronic receipt information of the member is received from the electronic receipt management server 4. In addition, the mobile terminal 7 displays the received electronic receipt information on the display unit 73 (which will be described later, see FIG. 8).

Furthermore, when the additional information is correlated with the received electronic receipt information, the mobile terminal 7 displays an icon or the like which indicates application to the project related to the campaign based on the additional information. For example, in the icon, it is possible to set connection destination information (a URL or the like) which indicates an application destination (for example, the promotion management server 6) to the project. In this case, when an operation with respect to the icon is received, the mobile terminal 7 accesses the promotion management server 6 via the network N5, and performs processing related to the application.

The promotion management server 6 is a server apparatus which accepts an access from the mobile terminal 7 connected via the network N5. The promotion management server 6 includes an entry master which manages application history for every campaign type in correlation with the membership code for identifying each member. When the application to the campaign is received from the mobile terminal 7 via the network N5, the promotion management server 6 manages the application history for every campaign type in correlation with the membership code. In addition, in a case where access to the promotion management server 6 is required, the mobile terminal 7 transmits the membership code related to the user's (member's) apparatus, which is maintained in the receipt data or the like.

In the electronic receipt system of the related configuration, the electronic receipt information (receipt data), which indicates the transaction (payment) content generated by performing the merchandise sales data processing at the POS terminal 1 of the store P1, is transmitted to the electronic receipt management server 4 via the electronic receipt server 3, and is disclosed on the web. Therefore, by designating the uniform resource locator (URL), the mobile terminal 7 which includes a web browser mounted thereon may download the receipt data disclosed on the web and read the data through the web browser. In addition, the data may be read by installing an application for reading the receipt data in the mobile terminal 7.

Next, a configuration of a main apparatus of the electronic receipt system according to the embodiment will be described.

First, a configuration of the POS terminal 1, which is the merchandise sales data processing apparatus, will be described. FIG. 3 is a block diagram illustrating a configuration of the POS terminal 1. As illustrated in FIG. 3, the POS terminal 1 includes a control unit 11 which performs each arithmetic operation and generally controls each portion of the POS terminal 1. The control unit 11 is a computer which is configured to have a central processing unit (CPU), a read only memory (ROM) which stores various programs or data, a random access memory (RAM) which temporarily stores various programs or freely stores various data by rewriting, and a real time clock (RTC) which measures current date and time, and the like.

The control unit 11 is connected to an input device 12, the printing unit 13, a display unit 14, and the code reading-out unit 15 via a bus 18.

The input device 12 includes various operation keys so that an operator performs an operation input. The operation keys may include a numeric key for inputting a numerical value, a cursor key or a selection determination key for selecting a predetermined item, a subtotal key for indicating a total output of the merchandise which is sales-registered in the transaction, and a settlement key for declaring that money is paid by performing a settlement processing of one transaction.

The input device 12 includes a keyboard on which the various operation keys, such as a settlement key 121, an association key 122, and a transmission key 123, are disposed. The settlement key 121 is a key operated when the transaction with the customer is completed. The association key 122 is a key operated after inputting the first customer specification information (hereinafter, referred to as “SRID”) which is the membership code for specifying the customer (hereinafter, referred to as “electronic receipt member”) who receives the electronic receipt information, and the second customer specification information (hereinafter, referred to as “PTID”) which is the membership code for specifying (that is, specifying the point member) a medium which is carried by the customer (hereinafter, referred to as “point member”) who enjoys the points. In the embodiment, the SRID is stored in the mobile terminal 7 (customer terminal) which is carried by the point member. In addition, the PTID is stored in a point card (member device) which is carried by the point member.

The transmission key 123 is a key operated for transmitting the input SRID and PTID to the electronic receipt server 3.

The printing unit 13 is includes a printer apparatus which operates printing, such as a receipt or a journal. The printing unit 13 performs the printing on a rolled paper sheet which is conveyed by a thermal head having a heating medium, for example, and then, issues the receipt by cutting the paper sheet.

The display unit 14 is a liquid crystal display or the like, and displays various information, such as the merchandise name of the merchandise registered for sales, the price, a total amount of money of one transaction whose payment is declared, and an amount of change. The display unit 14 includes a display 14a for the operator which displays various information toward a cashier, and a display 14b for the customer which displays various information toward the customer. In addition, the display unit 14 may include a touch panel. In this case, the touch panel functions as at least a portion of the input device 12.

The code reading-out unit 15 is a scanner apparatus which optically reads out the code symbol. The code reading-out unit 15 reads out the code symbol attached to the merchandise, or the code symbol displayed in the mobile terminal 7. The control unit 11 inputs the information maintained in the read-out code symbol. In the code symbol attached to the merchandise, the merchandise code or the like for specifying the merchandise is maintained. In the code symbol displayed in the mobile terminal 7, the SRID for specifying the member who carries the mobile terminal 7 is maintained. The SRID may be stored magnetically or electrically in the mobile terminal 7. In this case, the stored SRID is read out by a dedicated reading-out apparatus. The control unit 11 inputs the read-out SRID.

In addition, the control unit 11 is connected to the communication I/F (interface) 16 via the bus 18, and may be connected to the in-store network N1 or network N2 via the communication I/F 16.

The control unit 11 is connected to the storage unit 17 via the bus 18. The storage unit 17 is an auxiliary storage device, such as a hard disk drive (HDD) or a solid state drive (SSD). The storage unit 17 stores a program for performing various POS works including the merchandise sales data processing. In addition, the storage unit 17 stores various data files related to merchandise sales data processing, such as a merchandise data file which includes the merchandise name of each merchandise, the merchandise code, and unit price. In addition, the storage unit 17 stores a receipt data processing program 17a for performing merchandise sales data processing and processing related to the receipt data.

In addition, the storage unit 17 stores a POS number for distinguishing the POS terminal 1 from other POS terminals, a company code (identification code of the company which operates the store), a business type and business category code, and/or a store code which indicates the store P1 in which the POS terminal 1 is disposed, in an identification code management area 17b. Here, the business type and business category code distinguishes a business type and a business category of the store as a convenience store, a supermarket, a department store, a pharmacy, a restaurant, or an eating house, for example. In addition, the business type and the business category may be arbitrarily changed according to the preference of the user. In addition, the company code (identification code of the company which operates the store) and the business type and business category code may be registered in the electronic receipt server 3.

In addition, the storage unit 17 corresponds to each PTID of the point member, and includes a point storage unit 17c which stores points belonging to each member. The point storage unit 17c is a unit which downloads the information of the point master managed at the head office server 8 provided at the head office P2 by a batch processing.

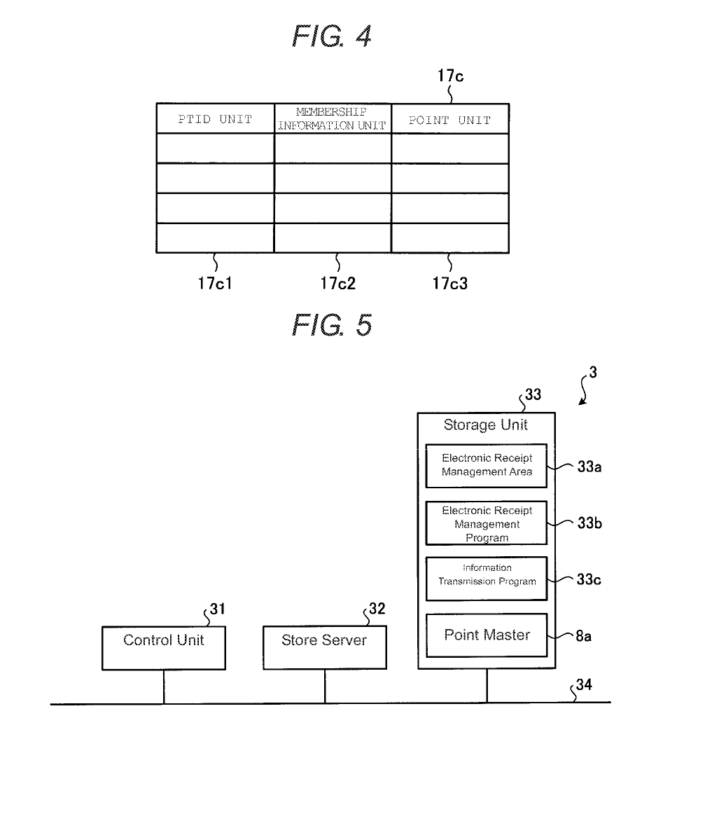

FIG. 4 is a memory map illustrating the point storage unit 17c. In FIG. 4, the point storage unit 17c includes a PTID unit 17c1, a membership information unit 17c2, and a point unit 17c3. The PTID unit 17c1 stores reward specification information which specifies the point card which is carried by the corresponding point member. The membership information unit 17c2 stores various information (name, address, age, gender, family structure and the like) of the corresponding member. The point unit 17c3 stores the number of points currently accumulated by using the corresponding point card.

Next, a configuration of the electronic receipt server 3 which functions as a receipt management server for the company will be described with reference to the block diagram of FIG. 5. The electronic receipt server 3 includes the control unit 31 which performs various arithmetic operations and generally controls each portion of the electronic receipt server 3. The control unit 31 is a computer which includes a CPU, a ROM which stores various programs or data, a RAM which temporarily stores various programs or freely stores various data by rewriting, and an RTC unit which measures the current date and time.

The control unit 31 may be connected to the network N2 or the network N3 via a communication I/F 32 which is connected to a bus 34. In addition, the control unit 31 is connected to the storage unit 33 via the bus 34.

The storage unit 33 stores the electronic receipt information for every company which operates a store in an electronic receipt management area 33a. The electronic receipt information includes the company code (identification code of the company which operates the store), the business type and business category code, the store code, the SRID of a shopper, the POS number of the POS terminal 1, a receipt number, or the merchandise sales data.

In addition, the storage unit 33 stores the electronic receipt management program 33b for managing the electronic receipt information. The storage unit 33 also stores an information transmission program 33c for transmitting the electronic receipt data to the electronic receipt management server 4.

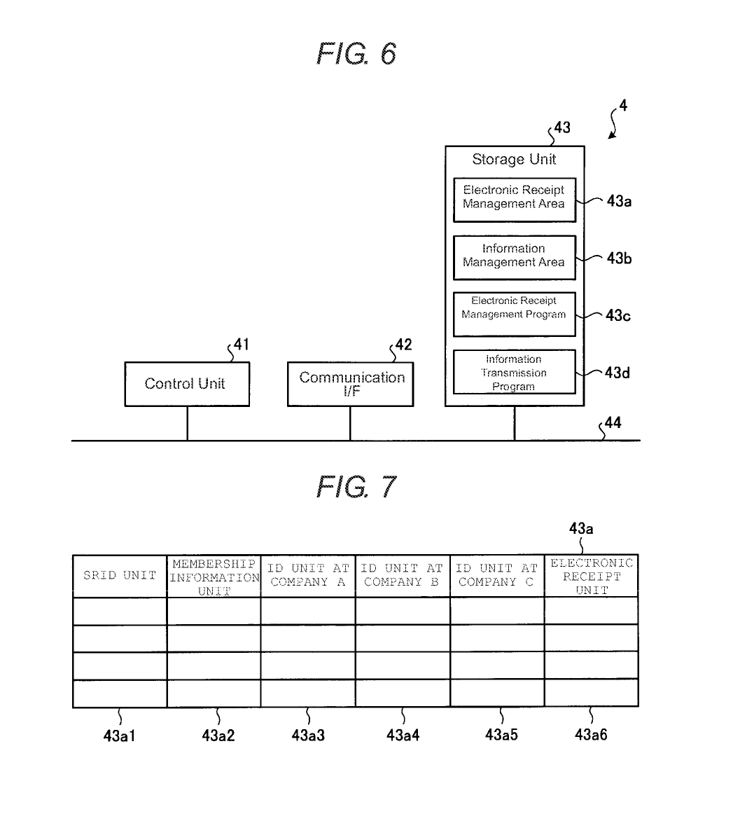

Next, a configuration of the electronic receipt management server 4 which functions as a receipt management server for the customer will be described with reference to the block diagram in FIG. 6. In FIG. 6, the electronic receipt management server 4 includes a control unit 41 which performs various arithmetic operations and generally controls each portion of the electronic receipt management server 4. The control unit 41 includes a CPU, a ROM which stores various programs or data, a RAM which temporarily stores various programs or stores various data by freely rewriting, and an RTC which measures the current date and time.

The control unit 41 may be connected to the network N3, the network N4, and the network N5 via a communication I/F 42 which is connected to a bus 44. In addition, the control unit 41 is connected to the storage unit 43 via the bus 44.

In the storage unit 43, an electronic receipt management area 43a for collectively storing the electronic receipt information of each company which operates the store is ensured, in addition to a membership master management area (not illustrated) for storing and managing the membership master. More specifically, the electronic receipt management area 43a manages the electronic receipt information of each company which operates a store, for every member.

The electronic receipt includes the SRID, the company code (identification code of the company which operates the store), the store code, the POS number of the POS terminal 1, the receipt number, or the merchandise sales data (including date and time data). Therefore, it is possible that the consumption goods maker P4 or the like obtains certification information of a unique purchased merchandise related to the corresponding maker, under a specific condition (for example, limitation to a specific company which operates the store, limitation to a specific area, or limitation to a specific time) from the electronic receipt information. The consumption goods maker P4 may be a maker of food, drinks, clothes, cosmetics, medicines, or household goods.

In addition, the storage unit 43 stores various additional information in correlation with a desired merchandise (merchandise code), the member (SRID), the company (company code), and the store (store code), in the additional information management area 43b. Here, the additional information may also include campaign information related to the campaign in correlation with the desired merchandise information and the specific condition (for example, the specific company which operates the store, the specific area, a specific store, or the specific time). The additional information may also include access information, such as a URL which links to a home page related to the campaign of the company, a URL which links to a home page related to a CM of the company, or a URL which links to a coupon of the company.

The storage unit 43 also stores an electronic receipt management program 43c for managing the electronic receipt information and the additional information of each company in the electronic receipt management area 43a and the additional information management area 43b, in addition to a membership management program (not illustrated) for managing the membership master in a membership master area. In addition, the storage unit 43 stores an information transmission program 43d for transmitting the electronic receipt information and the additional information of the desired merchandise, to the mobile terminal 7.

Next, with reference to the memory map of FIG. 7, a portion of the electronic receipt management area 43a of the electronic receipt management server will be described.

In FIG. 7, the electronic receipt management area 43a includes a SRID unit 43a1, a membership information unit 43a2, an ID 43a3 of a company A, an ID 43a4 of a company B, an ID 43a5 of a company C, and an electronic receipt unit 43a6.

The SRID unit 43a1 stores the SRID which specifies the mobile terminal 7 that delivers the electronic receipt information.

The membership information unit 43a2 stores property information (name, address, age, gender, family structure, and the like) of the member.

The ID 43a3 of the company A, the ID 43a4 of the company B, and the ID 43a5 of the company C respectively stores the company code which specifies the company A, the company B, and the company C, and the PTID which specifies the point card issued by each of the companies by associating the company code with the PTID. In addition, in the embodiment, in association with one SRID, the PTIDs of three companies, such as the company A, the company B, and the company C, are stored. However, this case is an example, and the PTIDs of many companies may be stored if the number of the companies is plural.

The electronic receipt unit 43a6 stores the electronic receipt information specified by the SRID. The electronic receipt unit 43a6 may store single type of electronic receipt information, and may store a plurality of types of electronic receipt information.

Next, a configuration of the mobile terminal 7 will be described with reference to the block diagram in FIG. 8. As illustrated in FIG. 8, the mobile terminal 7 includes a control unit 71 which performs various arithmetic operations and generally controls each portion of the mobile terminal 7. The control unit 71 is the computer which includes a CPU, a ROM which stores various programs or data, a RAM which temporarily stores various programs or freely stores various data by rewriting, and an RTC which measures the current date and time.

An input device 72 is connected to a display unit 73 via a bus 76. The input device 72 includes various operation keys and a pointing device so that the user (member) may perform an operation input. The display unit 73 is a liquid crystal display or the like, and displays various information, such as the electronic receipt information, which will be described later. In addition, the display unit 73 may have a touch panel. In this case, the touch panel functions as at least a portion of the input device 72.

In addition, the control unit 71 may be connected to a communication I/F 74 via the bus 76, and may be connected to the network N5 via the communication I/F 74. In addition, the control unit 71 may be configured to be connected to the in-store network N1 via the communication I/F 74.

In addition, the control unit 71 is connected to a storage unit 75 via the bus 76. The storage unit 75 stores an electronic receipt correspondence program 75a for receiving the electronic receipt information from the electronic receipt management server 4 and an electronic receipt reading program 75b for reading the received receipt data, in addition to the web browser for reading various information (content) which is disclosed on the web.

Next, example sequences of operations for each portion of the system according to the embodiment will be described.

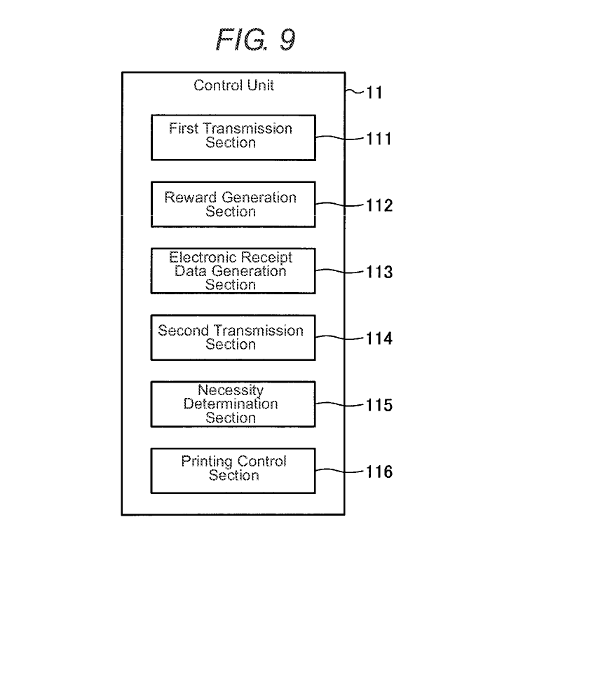

First, an electronic receipt processing, which is performed as the control unit 11 of the POS terminal 1 performs control according to the receipt data processing program 17a, will be described with reference to FIGS. 9 to 14.

FIG. 9 is a functional block diagram in the POS terminal. In FIG. 9, the receipt data processing program 17a performed at the POS terminal 1 is modularly includes a first transmission section 111, a reward generation section 112, an electronic receipt data generation section 113, a second transmission section 114, a necessity determination section 115, and a printing control section 116. As the CPU of the control unit 11, as the actual hardware, reads out and performs the receipt data processing program 17a from the storage unit 17, the functions of the first transmission section 111, the reward generation section 112, the electronic receipt data generation section 113, the second transmission section 114, the necessity determination section 115, and the printing control section 116 are performed.

The first transmission section 111 transmits the first customer specification information (SRID) to the outside apparatus, when the first customer specification information—which specifies the customer who receives the electronic receipt data related to the merchandise sales data—is input from the input device.

The reward generation section 112 generates the reward information which gives the point member a reward based on the merchandise sales data, when the second customer specification information (PTID) which specifies the point member is received from the outside apparatus (i.e., the first customer specification information (SRID) transmitted by the first transmission section 111).

The electronic receipt data generation section 113 generates the electronic receipt data including the reward information generated by the reward generation section 112.

The second transmission section 114 transmits the second customer specification information (PTID) to the outside apparatus (electronic receipt server), when the first customer specification information (SRID) is not input, and when the second customer specification information (PTID) is input from the input device.

The necessity determination section 115 determines that necessity of the reception of the electronic receipt data is input.

The printing control section 116 prints the merchandise sales data related to the merchandise sales and the generated reward information with the printing unit 13, when the first customer specification information (SRID) is not received from the outside apparatus (electronic receipt server), in response to the transmission of the second customer specification information (PTID).

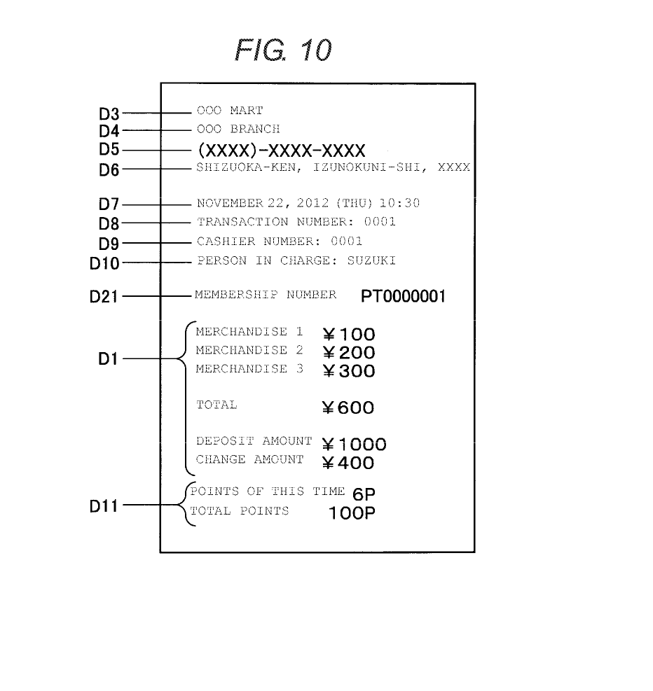

FIG. 10 illustrates an example of the receipt data. Here, the receipt data is text data in a non-structured form or the like, and is used in printing at the printing unit 13. As illustrated in FIG. 10, the receipt data includes merchandise sales data D1, point information D11 of the points of this time and accumulated points, and information D21 which indicates the PTID of the point member. Here, merchandise sales data D1 has the merchandise name (merchandise code) of the merchandise to be bought/sold, the price of the merchandise, the total amount of money of each merchandise, the deposit amount paid by the customer, and the change amount. In addition, the information D21 may be printed by masking a portion or the entirety of the information D21.

In addition, the receipt data also includes other elements, such as a company code (company name) D3 which indicates the company which operates the store, a store code (store name) D4, a telephone number of the store D5, an address D6, a transaction date and time D7, a transaction number (receipt number) D8, a cashier number D9, a name of a person in charge D10, and a point accounting D11. In addition, the element included in the receipt data is not limited to the example of FIG. 10, and may include other elements, such as the business type and business category code, and may exclude certain elements, such as the telephone number D5 or the address D6.

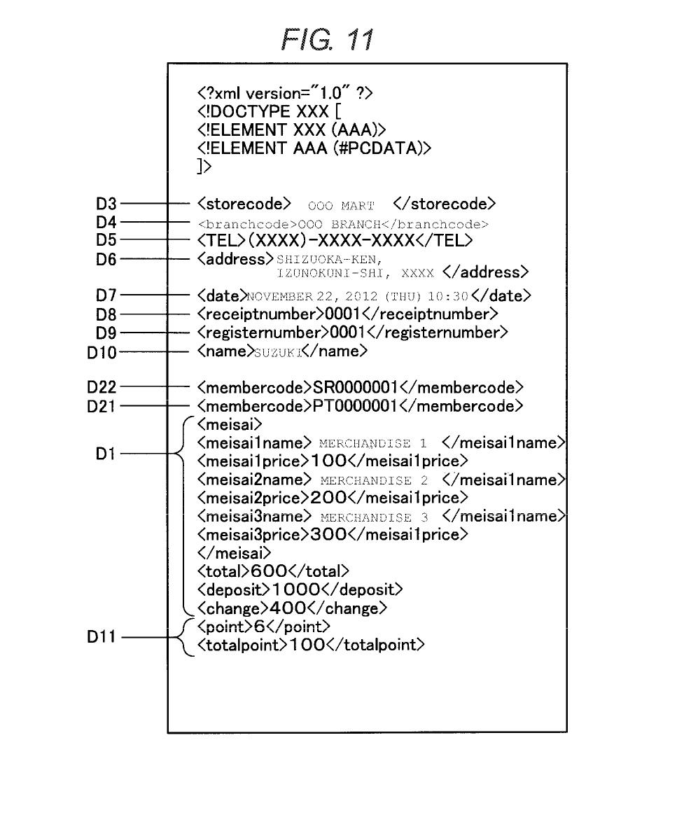

FIG. 11 illustrates another example of the electronic receipt information. As illustrated in FIG. 11, the electronic receipt information is configured to have data in a structured format, such as XML or CSV. In addition, in FIG. 11, an example is illustrated in which each element (D1 to D11) of the receipt data illustrated in FIG. 10 is converted into XML form. In addition, the electronic receipt information of FIG. 11 includes the point accounting information D11 (the points awarded this time and the accumulated points), the information D21 which indicates the PTID of the point member, and information D22 which indicates the SRID of the electronic receipt member. In addition, the information D21 and the information D22 may be displayed by masking a portion or the entirety of the information D21.

The conversion from the receipt data to the electronic receipt information is performed based on a conversion rule described in a receipt data schema (not illustrated). Specifically, in the receipt data schema, a predetermined element (which configures the receipt data) and the property information (tag or the like, which indicates the property of the element) are defined. The control unit 11 generates the electronic receipt information in a structured form as illustrated in FIG. 11, by structuring each element of the receipt data by using corresponding property information. In this manner, by making the electronic receipt information of the structured form, it is possible to efficiently use the element included in the corresponding receipt information, and thus it is possible to acquire various advantages in the data management.

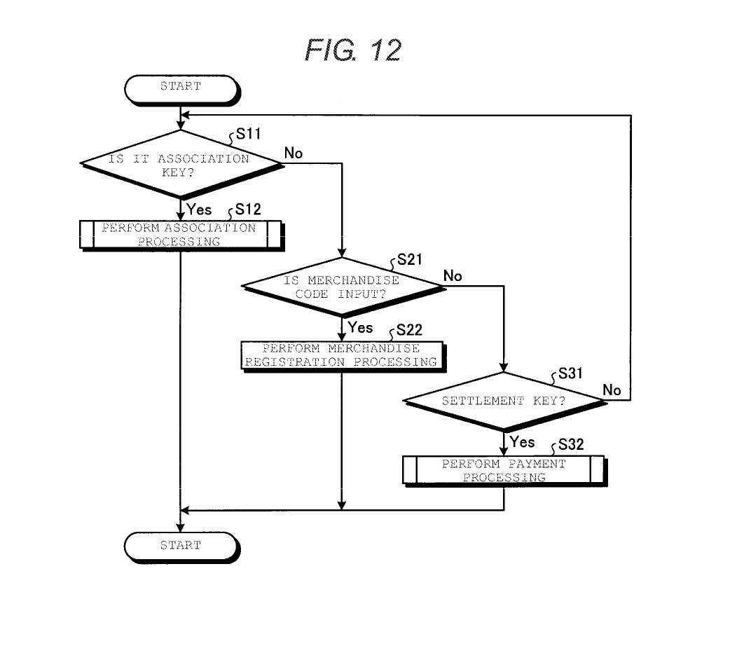

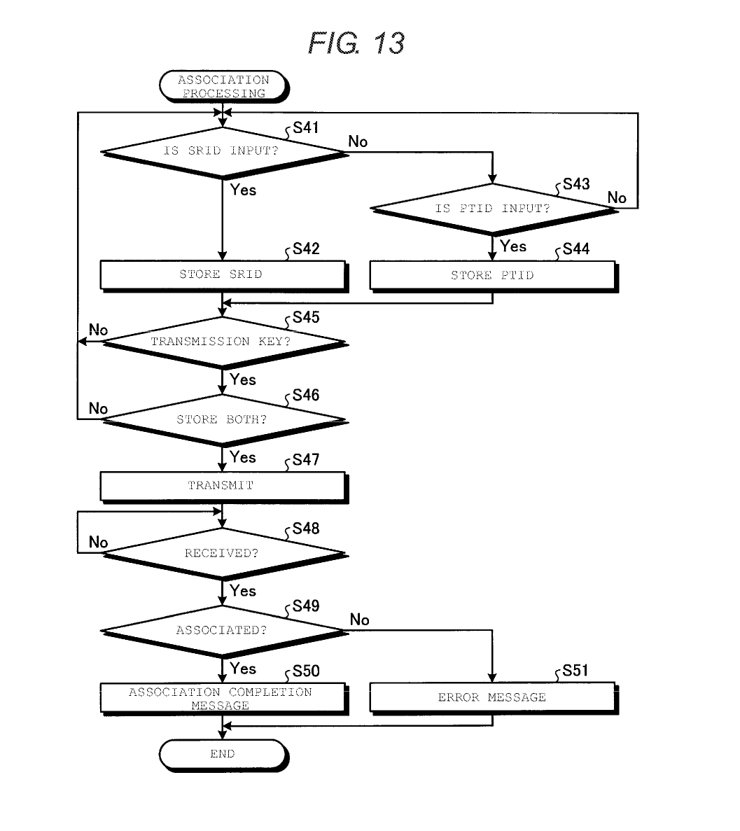

FIG. 12 is a flow chart illustrating an example sequence of operation for an electronic receipt information processing in the POS terminal 1. First, the control unit 11 of the POS terminal 1 determines whether the association key 122 is operated (Step S11). When it is determined that the association key 122 is operated (YES in Step S11), the control unit 11 performs an association processing between the SRID and the PTID as illustrated in FIG. 13 (Step S12).

When it is determined that the association key 122 is not operated (NO in Step S11), the control unit 11 determines whether the merchandise code which is included in the code symbol attached to the merchandise is read out and input by the code reading-out unit 15 (Step S21). When it is determined that the merchandise code is input (YES in Step S21), the control unit 11 performs a merchandise registration processing based on the corresponding merchandise code (Step S22).

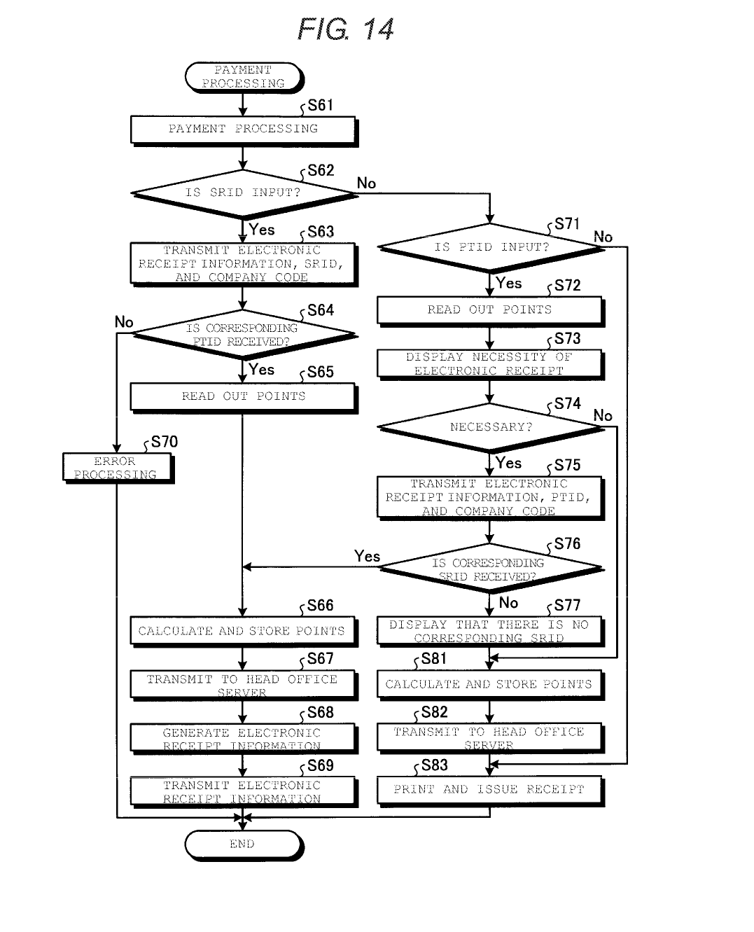

When it is determined that the merchandise code is not input (NO in Step S21), the control unit 11 determines whether the settlement key 121 is operated (Step S31). When it is determined that the settlement key 121 is operated (YES in Step S31), the control unit 11 performs a payment processing of FIG. 14 (Step S32). When it is determined that the settlement key 121 is not operated (NO in Step S31), the control unit 11 goes back to Step S11.

FIG. 13 is a flow chart illustrating an example sequence of operations for the association processing of Step S12 in detail. First, the control unit 11 determines whether the SRID is input (Step S41). In the embodiment, the bar code displayed on the display unit 73 of the mobile terminal 7 is read out by the code reading-out unit 15, and the SRID is input. When it is determined that the SRID is input (YES in Step S41), the control unit 11 stores the input SRID in the RAM inside the control unit 11 (Step S42).

When it is determined that the SRID is not input (NO in Step S41), the control unit 11 determines whether the PTID is input (Step S43). In the embodiment, the PTID reads out the bar code printed on the point card carried by the member by the code reading-out unit 15, and inputs the bar code. When it is determined that the PTID is input (YES in Step S43), the control unit 11 stores the input PTID in the RAM inside the control unit 11, together with the company code which issues the point card of the corresponding PTID (Step S44).

After inputting the SRID and the PTID, the member operates the transmission key 123. The control unit 11 determines whether the transmission key 123 is operated (Step S45). When it is determined that the transmission key 123 is operated (YES in Step S45), then, the control unit 11 determines whether or not both of the SRID and the PTID are stored in the RAM (Step S46).

When it is determined that both of the SRID and the PTID are stored (YES in Step S46), the control unit 11 transmits an association command which indicates the processing for the SRID, the PTID, and the company code, which are stored in the RAM, and the association processing, to be performed, to the electronic receipt server 3 (Step S47). Next, the control unit 11 determines whether information related to the association between the SRID and the PTID is received from the electronic receipt server 3 (Step S48).

When the process stands by until the information related to the association is received (NO in Step S48), and when it is determined that the information related to the association is received (YES in Step S48), at this time, the control unit 11 determines whether the association between the SRID and the PTID is completed (Step S49). When it is determined that the association between the SRID and the PTID is completed (YES in Step S49), the control unit 11 displays a message which indicates that the association is completed on the display unit 14 (Step S50). In addition, when it is determined that the association is not completed at this time (NO in Step S49), the control unit 11 displays a message which indicates that the association is not completed, together with a reason, such as a case where the association is already performed, or a case where the association is not completed. (Step S51).

In addition, when it is determined that the PTID is not input in Step S43 (NO in Step S43), when it is determined that the transmission key 123 is not operated in Step S45 (NO in Step S45), and when it is determined that both of the SRID and the PTID are not stored in the RAM in Step S46 (NO in Step S46), the control unit 11 goes back to Step S41.

FIG. 14 is a flow chart illustrating an example sequence of operations for the payment processing of Step S32 in detail. In FIG. 14, the control unit 11 performs the payment processing based on the merchandise registration processing performed in Step S22 (Step S61).

Next, the control unit 11 determines which one of the SRID and the PTID is input. First, the control unit 11 determines whether the SRID is input (Step S62). When it is determined that the SRID is input (YES in Step S62), the control unit 11 (first transmission section 111) transmits the SRID and the company code to the electronic receipt server 3 (Step S63).

Here, the company code is a code which specifies the company which issues the point card that stores the PTID. In the embodiment, the target is point cards issued by three companies, such as company A, company B, and company C. The company code is stored in the POS terminal 1, and is read out and transmitted from the POS terminal 1 when the company code is transmitted in Step S64. In addition, the company code may be a code which specifies point service which is operated by the company.

Next, the control unit 11 determines whether the PTID associated with the transmitted SRID is received from the electronic receipt server 3 (Step S64). When it is determined that the PTID is received (YES in Step S64), the control unit 11 reads out the points from the point unit 17c3 of the point storage unit 17c based on the received PTID (Step S65). Then, the control unit 11 (reward generation section 112) calculates accumulated points obtained by adding the points of this time computed by the payment processing of the Step S61, and stores the accumulated points in the point unit 17c3 (Step S66). Then, the control unit 11 transmits information including the points of this time and the accumulated points to the point master 8a of the head office server 8 (Step S67). The processing of Step S67 is subject to the batch processing.

Next, the control unit 11 (electronic receipt data generation section 113) generates the electronic receipt information which includes the point information D11 of the points of this time and the accumulated points, the information D22 of the SRID, and the information D21 of the PTID (Step S68). Then, the control unit 11 transmits the generated electronic receipt information to the electronic receipt server 3 (Step S69). The electronic receipt information may not include both of the information D22 of the SRID and the information D21 of the PTID, and may include at least one of them.

In addition, in Step S64, when it is determined that the PTID associated with the transmitted SRID is not received (NO in Step S64), the control unit 11 performs an error processing (Step S70).

Meanwhile, in Step S62, when it is determined that the SRID is not input (NO in Step S62), the control unit 11 determines whether or not the PTID is input (Step S71). When it is determined that the PTID is input (YES in Step S71), the control unit 11 reads out the points from the point unit 17c3 of the point storage unit 17c (Step S72).

Next, with respect to the member, the control unit 11 displays whether the reception of the electronic receipt information by the mobile terminal 7 is necessary on the display 14b for the customer of the display unit 14 (Step S73). When the member desires to receive the receipt as the electronic receipt, the member selects and operates a key of “Electronic receipt is necessary” displayed on the display 14b for the customer. In addition, when the member desires to receive the receipt as the paper receipt, the member selects and operates a key of “Electronic receipt is not necessary” displayed on the display 14b for the customer.

The control unit 11 (necessity determination section 115) determines whether the key of “Electronic receipt is necessary” is operated (Step S74). When it is determined that the key of “Electronic receipt is necessary” is operated (YES in Step S74), the control unit 11 (second transmission section 114) transmits the PTID and the company code to the electronic receipt server 3 (Step S75).

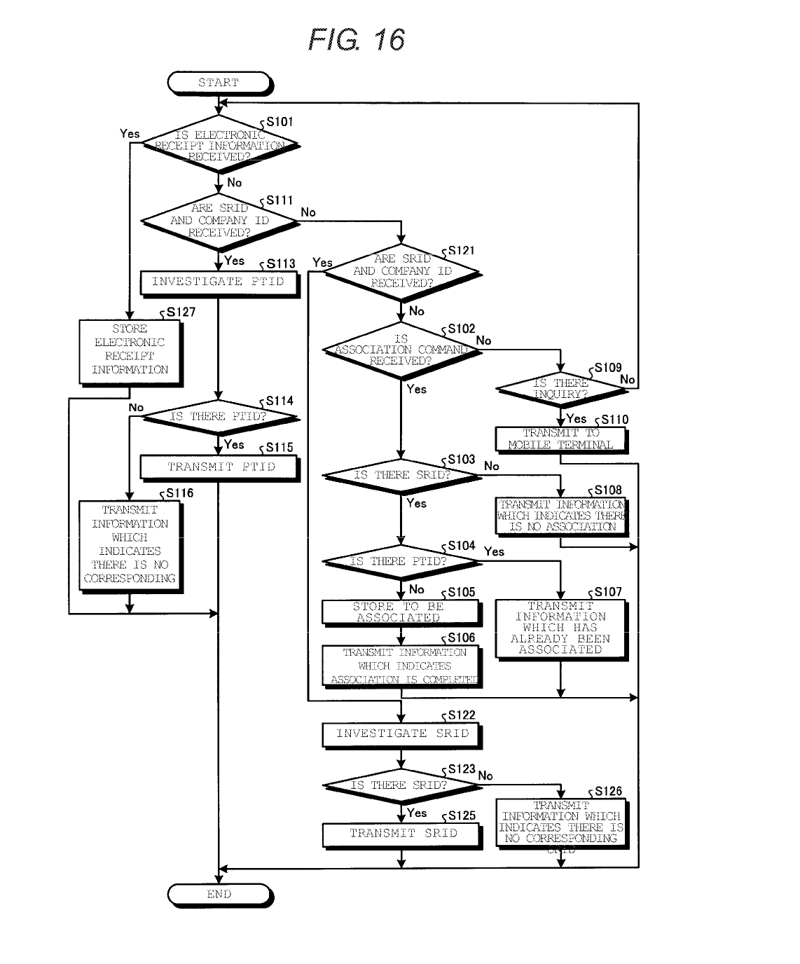

Next, the control unit 11 determines whether the associated SRID is received from the electronic receipt server 3 (Step S76). In this case, the control unit 11 determines that a case where the associated SRID transmitted in Step S125 of FIG. 16 which will be described later is received is YES, and that a case where information which indicates that there is no associated SRID transmitted in Step S126 of FIG. 16 is received is NO. When it is determined that the SRID is received (YES in Step S76), the control unit 11 performs the processing from Step S66 to Step S69.

In addition, when it is determined the information which indicates that there is no associated SRID is received (NO in Step S76), the control unit 11 displays a message which indicates that the corresponding SRID is not present (Step S77). Then, the control unit 11 calculates the accumulated points obtained by adding the points of this time calculated by the payment processing of Step S61, and stores the accumulated points in the point unit 17c3 (Step S81). Then, the control unit 11 transmits the information including the stored points and the PTID to the point master 8a of the head office server 8 (Step S82). Then, the control unit 11 (printing control section 116) prints the information D21 of the PTID, the information D11 of the points of this time and the accumulated points, and the information based on the payment processing of Step S61 by the printing unit 13, and issues the receipt as illustrated in FIG. 10 (Step S83).

In addition, in Step S74, when it is determined that the key of “Electronic receipt is not necessary” is operated (NO in Step S74), the control unit 11 performs a processing following Step S81. In addition, in Step S71, when it is determined that the PTID is not input (NO in Step S71), the control unit 11 performs the processing of Step S83.

In this manner, according to the embodiment, when the PTID which specifies the point member is received from the electronic receipt server 3, responding to the transmission of the SRID, the reward information which gives the point member the reward based on the merchandise sales data is generated. For this reason, only by carrying the mobile terminal 7, the point member may receive the electronic receipt without carrying the point card, and it is possible to give the points to the point member.

In addition, according to the embodiment, the company code is transmitted together with the SRID. For this reason, even when a plurality of PTIDs is associated with the SRID, it is possible to specify one PTID based on the transmitted company code.

In addition, according to the embodiment, when the PTID is input without inputting the SRID, the electronic receipt data is generated and transmitted to the electronic receipt server 3 together with the PTID. For this reason, it is possible to generate the electronic receipt data by using the point card. In this case, the point member may select whether to receive the electronic receipt data or not.

In addition, in the embodiment, when the SRID is not received corresponding to the PTID, the points given with the merchandise sales data is printed on the paper receipt. For this reason, when the electronic receipt is not made, the point member may automatically receive the paper receipt.

In addition, the point card in the embodiment may be any card issued by the store. For example, the point card may be a card which is specialized in giving and using the points, and may be a card which may be used as the point card and as a credit card.

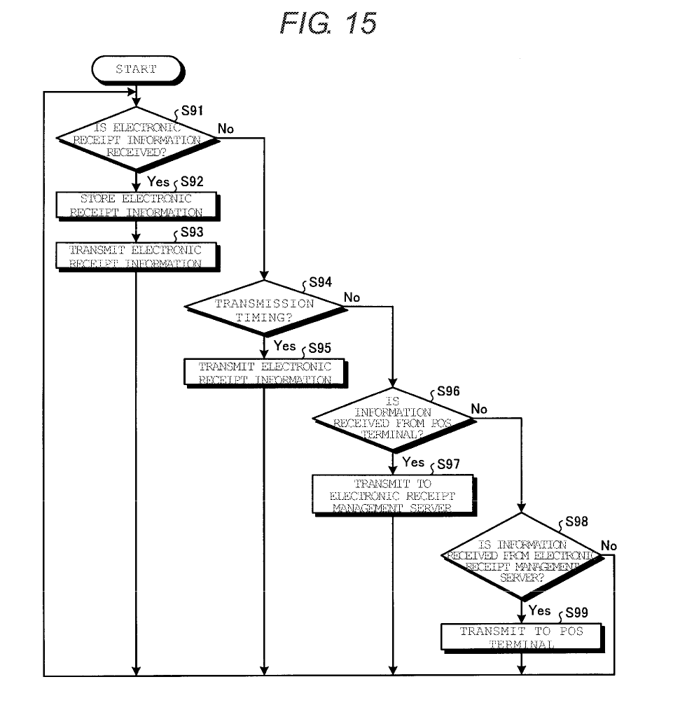

Next, an example sequence of operations for an electronic receipt management processing (which is performed by the control unit 31 of the electronic receipt server 3 operating according to the electronic receipt management program 33b), and an example sequence of operations for an information transmission processing (which is performed by the control unit 31 of the electronic receipt server 3 operating according to the information transmission program 33c) will be described with reference to a flow chart illustrated in FIG. 15.

The control unit 31 of the electronic receipt server 3 determines whether the electronic receipt information transmitted from the POS terminal 1 is received via the communication I/F 32 (Step S91). When it is determined that the electronic receipt information is received (YES in Step S91), the electronic receipt information is stored as the electronic receipt information for every company in the electronic receipt management area 33a of the storage unit 33 (Step S92). Then, the control unit 31 of the electronic receipt server 3 transmits the electronic receipt information stored in Step S92 to the electronic receipt management server 4 (Step S93), and goes back to Step S91.

In addition, in Step S91, when it is determined that the electronic receipt information is not received (NO in Step S91), the control unit 31 determines whether or not the timing is a transmission timing set in advance (Step S94). When it is determined that the timing is the transmission timing (YES in Step S94), the control unit 31 transmits the electronic receipt information which is stored and managed in the electronic receipt management area 33a, to the electronic receipt management server 4 (Step S95), and goes back to Step S91. By the transmission in Step S95, it is possible to transmit the electronic receipt information leaked from the target of the transmission in Step S93 to the electronic receipt management server 4, for example. In addition, in Step S95, only non-transmitted electronic receipt information may be controlled to be transmitted.

In addition, in Step S94, when it is determined that the timing is not the transmission timing set in advance (NO in Step S94), the control unit 31 determines whether the information is received from the POS terminal 1 (Step S96). The information to be received is the SRID, the PTID, or the company code. When it is determined that the information is received (YES in Step S96), the control unit 31 transmits the corresponding received information to the electronic receipt management server 4 (Step S97).

In addition, when it is determined that the information is not received from the POS terminal 1 (NO in Step S96), the control unit 31 determines whether the information is received from the electronic receipt management server 4 (Step S98). The information to be received is the SRID, the PTID, associated association information, error information, or message information. When it is determined that the information is received (YES in Step S98), the control unit 31 transmits the corresponding received information to the POS terminal 1 (Step S99). When it is determined that the information is not received (NO in Step S98), the control unit 31 goes back to Step S91.

Next, an example sequence of operations for an electronic receipt management processing (which is performed by the control unit 41 of the electronic receipt management server 4 operating according to the electronic receipt management program 43c, and an example sequence of operations for a merchandise information transmission processing (which is performed by the control unit 41 of the electronic receipt management server 4 operating according to the information transmission program 43d) will be described with reference to a flow chart illustrated in FIG. 16.

In FIG. 16, the control unit 41 determines whether the electronic receipt information is received from the electronic receipt server 3 (Step S101). When it is determined that the electronic receipt information is received (YES in Step S101), the control unit 41 stores the received electronic receipt information in the electronic receipt unit 43a6 of the electronic receipt management area 43a corresponding to the SRID (Step S127). Then, the control unit 41 ends the processing.

When it is determined that the electronic receipt information is not received (NO in Step S101), then, the control unit 41 determines whether or not the SRID and a company ID are received (Step S111). When it is determined that the SRID and the company ID are received (YES in Step S111), the control unit 41 investigates the corresponding PTID, based on the received SRID and the company ID (Step S113). In the embodiment, in response to the received company code, whether any of the PTIDs company A, company B or company C exist is investigated.

Then, the control unit 41 determines whether there is a corresponding PTID (Step S114). When it is determined that there is a corresponding PTID (YES in Step S 114), the control unit 41 (reward specification information output section 414) reads out the PTID which corresponds to the company code, and transmits the PTID to the electronic receipt server 3 (Step S115).

In addition, when it is determined that the received company code is not the company code of the company A, the company B, or the company C, and that there is no corresponding PTID (NO in Step S114), the control unit 41 transmits the information which indicates that there is no PTID associated with the received SRID, to the electronic receipt server 3 (Step S116).

Meanwhile, in Step S111, when it is determined that the SRID and the company code are not received together with the electronic receipt information (NO in Step S111), the control unit 41 (reward specification information determination section 415) determines whether the PTID and the company code are received (Step S121).

When it is determined that the PTID and the company code are received (YES in Step S121), the control unit 41 investigates the corresponding SRID, based on the received PTID and the company code (Step S122). Then, the control unit 41 determines whether there is a corresponding SRID (Step S123). When it is determined that there is a corresponding SRID (YES in Step S123), the control unit (electronic receipt specification information output section 416) transmits the corresponding SRID to the electronic receipt server 3 (Step S125). In addition, when it is determined that there is no corresponding SRID (NO in Step S123), the control unit 41 transmits information which indicates that there is no corresponding SRID, to the electronic receipt server 3 (Step S126).

Meanwhile, in Step S121, when it is determined that the PTID and the company code are not received (NO in Step S121), the control unit 41 (input determination section 412) determines whether both of the SRID and the PTID and the company code are received simultaneously (Step S102).

When it is determined that both of the SRID and the PTID are received (YES in Step S102), the control unit 41 determines whether the received SRID is stored in the SRID unit 43a1 of the electronic receipt management area 43a (Step S103). When it is determined that the SRID is stored (YES in Step S103), the control unit 41 determines whether the PTID is stored in association with the corresponding SRID (Step S104).

When it is determined that the PTID is not stored (NO in Step S104), the control unit 41 (storage section 411) stores the corresponding SRID, and stores the PTID in any area which is specified by the company code received in Step S102 simultaneously, in association with the corresponding SRID (Step S105). According to FIG. 7, the specified area may be the ID unit 43a3 of company A when the company code is the company code of company A, the ID unit 43a4 of company B when the company code is the company code of company B, and the ID unit 43a5 of company C when the company code is the company code of company C. Then, the control unit 41 transmits information which indicates that the association between the SRID and the PTID is completed, to the electronic receipt server (Step S106).

In a case of the embodiment, it is possible to associate the PTID of the point card issued by company A, the PTID of the point card issued by company B, and the PTID of the point card issued by company C, with one SRID. In other words, it is possible to associate one member with three types of point cards. In addition, as described above, three types are an example, and the type of point card may be one, two or more.

In addition, when it is determined that the PTID is already stored (YES in Step S104), the control unit 41 transmits the information which already associates with the SRID and the corresponding PTID to the electronic receipt server 3 (Step S107).

In addition, in Step S103, when it is determined that the received SRID is not stored in the SRID unit 43a1 (NO in Step S103), the control unit 41 transmits information indicating that there is no corresponding SRID to the electronic receipt server 3 (Step S108).

In addition, in Step S102, when it is determined that both of the SRID and the PTID and the company code are not received (NO in Step S102), the control unit 41 determines whether or not there is an inquiry about the electronic receipt information from the mobile terminal 7 (Step S109). When it is determined that there is the inquiry (YES in Step S109), the control unit 41 transmits the corresponding electronic receipt information to the mobile terminal 7 in which there is the inquiry (Step S110). When it is determined that there is no inquiry about the electronic receipt information from the mobile terminal 7 (NO in Step S109), the control unit 41 goes back to Step S101 and stands by.

Meanwhile, in Step S101, when it is determined that the electronic receipt information is received (YES in Step S101), the control unit 41 (operating as electronic receipt specification determination section 413) determines whether the SRID and the company code are received together with the electronic receipt information (Step S111).

When it is determined that the SRID and the company code are received together with the electronic receipt information (YES in Step S111), the control unit 41 stores the received electronic receipt information in the electronic receipt unit 43a6 of the electronic receipt management area 43a corresponding to the SRID (Step S112). Then, the control unit 41 investigates the corresponding PTID, based on the received SRID and the company code (Step S113). With respect to the received company code, whether any of the PTIDs of company A, company B, or company C exist is investigated.

Then, the control unit 41 determines whether there is a corresponding PTID (Step S114). When it is determined that there is a corresponding PTID (YES in Step S114), the control unit 41 (operating as reward specification information output section 414) reads out the PTID which corresponds to the company code, and transmits the PTID to the electronic receipt server 3 (Step S115).

In addition, when it is determined that the received company code is not the company code of the company A, the company B, or the company C, and that there is no corresponding PTID (NO in Step S114), the control unit 41 transmits the information which indicates that there is no PTID associated with the received SRID, to the electronic receipt server 3 (Step S116).

Meanwhile, in Step S111, when it is determined that the SRID and the company code are not received together with the electronic receipt information (NO in Step S111), the control unit 41 (reward specification information determination section 415) determines whether or not the PTID and the company code are received together with the electronic receipt information (Step S121).

When it is determined that the PTID and the company code are received (YES in Step S121), the control unit 41 investigates the corresponding SRID, based on the received PTID and the company code (Step S122). Then, the control unit 41 determines whether there is the corresponding SRID (Step S123). When it is determined that there is the corresponding SRID (YES in Step S123), the control unit 41 stores the electronic receipt information corresponding to the SRID (Step S124). Then, the control unit 41 (electronic receipt specification information output section 416) transmits the corresponding SRID to the electronic receipt server 3 (Step S125). In addition, when it is determined that there is no corresponding SRID (NO in Step S123), the control unit 41 transmits information which indicates that there is no corresponding SRID, to the electronic receipt server 3 (Step S126).

Furthermore, in Step S121, when it is determined that the PTID and the company code are not received together with the electronic receipt information (NO in Step S121), the control unit 41 transmits information which indicates the error to the electronic receipt server 3 (Step S127).

In the embodiment, since the SRID and the PTID are stored in association with each other, it is possible to carry out service which allows the customer who carries the mobile device for the electronic receipt to be in cooperation with the point member.

In addition, in the embodiment, when it is determined that the SRID and the PTID are input simultaneously, since the SRID and the PTID are stored in association with each other, it is possible to store the SRID and the PTID first in association with each other, for example.

In addition, in the embodiment, the associated PTID is output based on the input SRID. For this reason, when the SRID is input from the mobile terminal 7, for example, it is possible to give the points to the related PTID, even without the point card. Therefore, the point card need not be carried. In this case, all of the plurality of point cards which associated with the SRID and the PTID need not be carried. For example, the point card of the company A, the point card of the company B, and the point card of the company C need not be carried.

In addition, in the embodiment, the associated SRID is output based on the input PTID. For this reason, it is possible to store the electronic receipt information corresponding to the associated SRID.

In addition, in the embodiment, the associated SRID is output based on the input PTID. For this reason, when the point card is shown, even without inputting the SRID from the mobile terminal 7, it is possible to receive the electronic receipt information with respect to the associated SRID. Therefore, the mobile terminal 7 need not be carried.

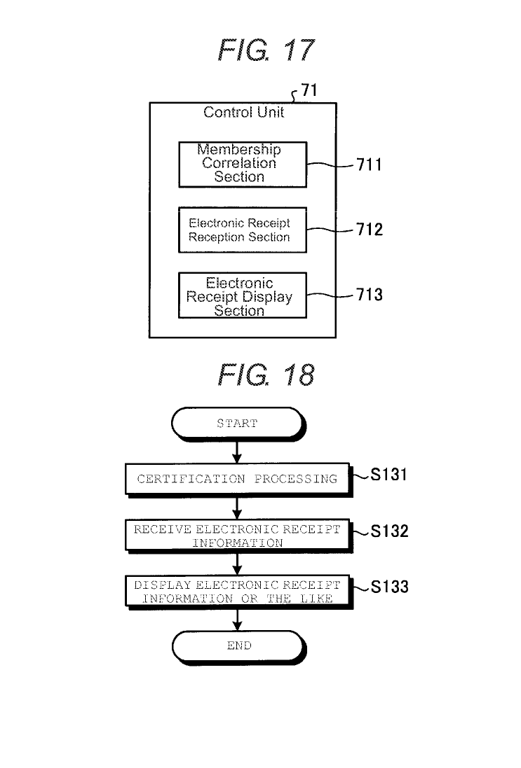

Next, a flow of an electronic receipt reception processing which is performed as the control unit 71 of the mobile terminal 7 is operated according to the electronic receipt correspondence program 75a, and a flow of an electronic receipt reading processing which is performed as the control unit 71 of the mobile terminal 7 is operated according to the electronic receipt reading program 75b, will be described with reference to flow charts illustrated in FIGS. 17 and 18.

As illustrated in FIG. 17, the electronic receipt correspondence program 75a and the electronic receipt reading program 75b, which are performed at the mobile terminal 7, modularly include a membership correlation section 711, an electronic receipt reception section 712, and an electronic receipt display section 713. The CPU of the control unit 71, as the actual hardware, reads out the electronic receipt correspondence program 75a and the electronic receipt reading program 75b from the storage unit 75, and performs according to the electronic receipt correspondence program 75a and the electronic receipt reading program 75b. Accordingly, the each portion described above is loaded onto the RAM, and the membership correlation section 711, the electronic receipt reception section 712, and the electronic receipt display section 713 are generated on the RAM.

The membership correlation section 711 is correlated with the membership code of a predetermined customer. The electronic receipt reception section 712 receives the electronic receipt information from the electronic receipt management server 4. The electronic receipt display section 713 displays the electronic receipt information received by the electronic receipt reception section 712, on the display unit 73.

As shown in FIG. 18, first, the membership correlation section 711 of the mobile terminal 7 performs a certification processing by accessing the electronic receipt management server 4 and by inputting the membership code and the password (Step S131). Accordingly, the mobile terminal 7 and the membership code of the predetermined customer are correlated with each other.

After the certification, the electronic receipt reception section 712 of the mobile terminal 7 receives the electronic receipt information which is stored and managed in the electronic receipt management area 43a, corresponding to the input corresponding membership code (Step S132). In addition, when the additional information correlates with the electronic receipt information, even the additional information is received from the electronic receipt management server 4. In addition, the receipt data may be received by email.

Next, the electronic receipt display section 713 of the mobile terminal 7 displays the electronic receipt information received by the electronic receipt reception section 712 or the like on the display unit 73 (Step S133), and ends the processing.

In the above, although an embodiment is described, the embodiment is disclosed as an example, and the range of the exemplary embodiment is not limited. The embodiment may carry out other various embodiments, and it is possible to add various omissions, changes, modifications, and combinations without departing from the scope of the exemplary embodiment. The embodiment and the modification thereof is included in the range or the scope of the exemplary embodiment, and is included in the range equivalent to that of the exemplary embodiment mentioned in a range of claims.

For example, in the above-described embodiment, the membership code or the like is input by using the code reading-out unit 15. However, the embodiment is not limited thereto, and the membership code or the like may be input by using another method. For example, the POS terminal 1 and the mobile terminal 7 may be provided with a short-range radio communication unit, such as a near field communication (NFC) or a Bluetooth (registered trademark). Therefore, the membership code or the like may be transmitted and received by the short-range radio communication. In this case, the mobile terminal 7 maintains the membership code or the like in the storage unit 75 or in an IC tag (not illustrated) or the like.

In addition, in the above-described embodiment, the PTID which specifies the point card is described as an example. However, even a card which gives the reward to the member, in addition to the point card, may be employed. In addition, even a medium, in addition to a card, may be employed.

In addition, in the above-described embodiment, the mobile terminal 7 is used as an example of the customer terminal. However, the customer terminal may be a personal computer or a tablet computer.

In addition, in the above-described embodiment, the membership code or the like is input from the mobile terminal 7. However, the embodiment is not limited thereto, and the membership code or the like may be input from a medium which may maintain the membership code, such as an IC card or a magnetic card. In addition, when the IC card is used, the POS terminal 1 is provided with a reading-out and writing-in unit, such as an IC card reader or writer. In addition, when the magnetic card is used, the POS terminal 1 is provided with a card reader or a card writer of the magnetic card.

In addition, in the above-described embodiment, the electronic receipt server 3 is provided in the head office P2. However, the embodiment is not limited thereto, and the electronic receipt server 3 for the corresponding store may be provided in the store P1. In this case, the POS terminal 1 outputs the electronic receipt information to the electronic receipt server 3 which is connected to the in-store network N1 in the own store, and the electronic receipt server 3 transmits the electronic receipt information to the electronic receipt management server 4 via the in-store network N1 and the network N2.

In addition, in the above-described embodiment, the electronic receipt information generated at the POS terminal 1 is output to the electronic receipt management server 4 via the electronic receipt server 3. However, the embodiment is not limited thereto, and by accessing the electronic receipt management server 4 via the network N3 from the POS terminal 1, the electronic receipt information may be directly output to the electronic receipt management server 4.

In addition, in the above-described embodiment, the mobile terminal 7 receives the electronic receipt information via the electronic receipt management server 4. However, the embodiment is not limited thereto, and the electronic receipt information may be directly received from the POS terminal 1. In this case, the POS terminal 1 outputs the generated electronic receipt information with respect to the mobile terminal 7 which is connected via the in-store network N1 or the near field communication unit (not illustrated). In this case, the POS terminal 1 may perform the certification processing.

In addition, in the embodiment, the POS terminal 1 stores a merchandise data file. However, the embodiment is not limited thereto, and the store server 2 may store the merchandise data file to be able to be referred to from the POS terminal 1.

In addition, in the embodiment, although a reward member is described with an example of the point member, the reward member may be a member who enjoys any service from the store, including the points.

In addition, the program which is executed at the merchandise sales data processing apparatus according to the embodiment is provided to be recorded in a recording medium which is able to be read out by the computer, such as a CD-ROM, a flexible disk (FD), a CD-R, or a digital versatile disk (DVD), as a file in a format that may be installed or a format that may be executed.

In addition, the program which is executed at the merchandise sales data processing apparatus according to the embodiment may be stored on the computer connected to the network, such as the Internet, and may be configured to be provided by downloading through the network. In addition, the program which is executed at the merchandise sales data processing apparatus according to the embodiment may be configured to be provided through the network, such as the Internet, and to be distributed.

In addition, the program which is executed at the merchandise sales data processing apparatus according to the embodiment may be configured to be provided by previously incorporating in the ROM or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise sales data processing apparatus, comprising:
an input device configured to receive:
first customer information corresponding to a user who requests electronic receipt information corresponding to merchandise currently purchased at a store,
second customer information corresponding to the user and indicating the user's participation in a reward program in the store at which the user is currently purchasing merchandise, and
merchandise sales data corresponding to the user's current purchase of merchandise at the store;
a storage unit configured to store:
the received first customer information,
the second customer information,
company code information indicating the store, and
reward information corresponding to the user and including current reward information indicating a current reward amount accumulated in the reward program by the user, based on the merchandise sales data, and total reward information indicating a total reward amount accumulated in the reward program by the user; and
a processor configured to control the apparatus to function as:
a first transmission section that transmits the received first customer specification information and the company code information to an outside apparatus,
a privilege generation section that generates the reward information when the second customer specification information is received from the outside apparatus in response to the transmission of the first customer specification information and the company code information, and
an electronic receipt data generation section that generates and transmits the electronic receipt information including the merchandise sales data and the reward information.

2. The apparatus according to claim 1, wherein
the electronic receipt data generated by the electronic receipt data generation section includes at least one of the first customer specification information and the second customer specification information.

3. The apparatus according to claim 1, further comprising:
a second transmission section that transmits the received second customer specification information to the outside apparatus when the first customer specification information is not input, and when the second customer specification information is received from the input device.

4. The apparatus according to claim 3, wherein
the second transmission section transmits the company information in addition to the second customer specification information.

5. The apparatus according to claim 3, further comprising:
a necessity determination section that determines that the user has requested the electronic receipt information based on an input from the user, wherein
the second transmission section transmits the company information when the necessity determination section determines that the user has requested the electronic receipt information.

6. The apparatus according to claim 5, further comprising:
a printing control section that prints the merchandise sales data and the generated privilege information with a printing unit when the second customer specification information is not received from the outside apparatus in response to the transmission of the first customer specification information and the company code information.

7. The apparatus according to claim 6, wherein
the printing control section further prints the second customer specification information.

8. The apparatus according to claim 1, wherein
the user is one of a plurality of users, and the reward program is one of a plurality of independent reward programs, each offered in different stores.

9. A non-transitory computer readable medium containing instructions for a merchandise sales data processing apparatus including an input device, a storage device, and a processor, the instructions causing the apparatus to function as:
a receiving unit configured to receive first customer information corresponding to a user who requests electronic receipt information corresponding to merchandise currently purchased at a store, second customer information corresponding to the user and indicating the user's participation in a reward program in the store at which the user is currently purchasing merchandise, and merchandise sales data corresponding to the user's current purchase of merchandise at the store;
a storage unit configured to store the received first customer information, the second customer information, company code information indicating the store, and reward information corresponding to the user and including current reward information indicating a current reward amount accumulated in the reward program by the user, based on the merchandise sales data, and total reward information indicating a total reward amount accumulated in the reward program by the user;
a first transmission section that transmits the received first customer specification information and the company code information to an outside apparatus;
a privilege generation section that generates the reward information when the second customer specification information is received from the outside apparatus in response to the transmission of the first customer specification information and the company code information; and
an electronic receipt data generation section that generates and transmits the electronic receipt information including the merchandise sales data and the reward information.

10. The non-transitory computer readable medium according to claim 9, wherein
the electronic receipt data generated by the electronic receipt data generation section includes at least one of the first customer specification information and the second customer specification information.

11. The non-transitory computer readable medium according to claim 9, the instructions further causing the apparatus to perform as:
a second transmission section that transmits the received second customer specification information to the outside apparatus when the first customer specification information is not input, and when the second customer specification information is received from the input device.

12. The non-transitory computer readable medium according to claim 11, wherein
the second transmission section transmits the company information in addition to the second customer specification information.

13. The non-transitory computer readable medium according to claim 11, the instructions further causing the apparatus to perform as:
a necessity determination section that determines that the user has requested the electronic receipt information based on an input from the user, wherein
the second transmission section transmits the company information when the necessity determination section determines that the user has requested the electronic receipt information.

14. The non-transitory computer readable medium according to claim 13, the instructions further causing the apparatus to perform as:
a printing control section that prints the merchandise sales data and the generated privilege information with a printing unit when the second customer specification information is not received from the outside apparatus in response to the transmission of the first customer specification information and the company code information.

15. The non-transitory computer readable medium according to claim 14, wherein
the printing control section further prints the second customer specification information.

16. The non-transitory computer readable medium according to claim 9, wherein
the user is one of a plurality of users, and the reward program is one of a plurality of independent reward programs, each offered in different stores.

17. A method for merchandise sales data, the method comprising the steps of:
receiving, through an input device, first customer information corresponding to a user who requests electronic receipt information corresponding to merchandise currently purchased at a store, and merchandise sales data corresponding to the user's purchase of merchandise at the store;
storing, in a storage device, the received first customer information and company code information indicating the store, and;
transmitting the received first customer specification information and the company code information to an outside apparatus;
receiving, from the outside apparatus in response to the transmission of the first customer specification information and the company code information, second customer specification information corresponding to the user and indicating the user's participation in a reward program in the store at which the user is currently purchasing merchandise;
generating reward information corresponding to the user and including current reward information indicating a current reward amount accumulated in the reward program by the user, based on the merchandise sales data, and total reward information indicating a total reward amount accumulated in the reward program by the user; and
generating and transmitting the electronic receipt information including the merchandise sales data and the reward information.

18. The method according to claim 17, wherein
the electronic receipt data generated by the electronic receipt data generation section includes at least one of the first customer specification information and the second customer specification information.

19. The method according to claim 17, wherein
the printing control section further prints the second customer specification information.

20. The method according to claim 17, wherein
the user is one of a plurality of users, and the reward program is one of a plurality of independent reward programs, each offered in different stores.
